(19) United States
(12) Patent Application Publication
(10) Pub. No.: US 2017/0018333 A1
(43) Pub. Date: Jan. 19, 2017

(54) Connector Combination

(71) Applicant: COMPAL BROADBAND NETWORKS INC., Taipei City (TW)

(72) Inventors: Lung-Pin Chang, Hsinchu County (TW); Kuo-Liang Lee, Hsinchu County (TW); Hui-Ming Yu, Hsinchu County (TW)

(21) Appl. No.: 15/151,505

(22) Filed: May 11, 2016

Related U.S. Application Data
(60) Provisional application No. 62/193,099, filed on Jul. 16, 2015.

(30) Foreign Application Priority Data
Dec. 16, 2015 (TW) 104220170

(51) Int. Cl. H01B 11/18; H01R 9/05

(52) U.S. Cl. CPC H01B 11/1895; H01R 9/05

(57) ABSTRACT

A connector combination includes a transmission line and a connector. The transmission line includes a woven shield for providing a signal reference of a radio-frequency signal, and blocking noise to prevent the radio-frequency signal from being interfered with the noise. The connector is coupled to the transmission line, includes a pipe, wherein a soldering area is formed on the pipe for allowing the woven shield to be soldered with the pipe after the transmission line is combined with the connector.

### CROSS REFERENCE TO RELATED APPLICATIONS

This application claims the benefit of U.S. Provisional Application No. 62/193,099, filed on 2015 Jul. 16, the contents of which are incorporated herein.

### BACKGROUND OF THE INVENTION

1. Field of the Invention

The present invention relates to a connector combination, and more particularly, relates to a connector combination with seamless noise block by soldering a woven shield of a transmission line with a soldering area of a connector.

2. Description of the Prior Art

Cable electronic products such as cable modem and cable television set-top box are designed with a radio-frequency (RF) connector, hereinafter called F-connector, wherein the F-connector is used for connecting the cable with the cable modem or cable television set-top box to transmit radio-frequency signals. Basic requirements for the F-connector include return loss for avoiding reflecting noise from the cable signal system. Also, insertion loss ensures the signal quality for tuners of the cable modem and the cable television set-top.

Recently, the popularity of handheld products brings evolution of mobile communication systems, where different mobile communication systems can support communication schemes such as amplitude modulation (AM), Global System for Mobile Communication (GSM) standard by third Generation Partnership Project (3GPP), and/or long term evolution (LTE) for wireless communication, and interactions between wired and wireless communications can be achieved. To ensure signal quality, the challenge of noise blocking for cable electronic products rises. In the traditional cable electronic products, the F-connector is connected by riveting and tin soldering, wherein noise blocking is achieved by soldering the tin onto the seam between the transmission line and the connector, or pasting a conductive patch onto the seam.

In addition, considering aesthetic design, many cable electronic products are designed with chic and smooth appearances, thereby the design of the F-connector becomes more flexible in order to adapt to the chic and smooth appearances. Most of the transmission lines in the market are used for products with Wi-Fi communication, while the transmission lines used for the F-connector of the cable products are quite rare, and its performance for noise blocking is bad.

For a cable (including a transmission line and a connector) with 75 ohms impedance, it is traditionally fixed by crimping. For example, an operator exposes the conductor of the cable to contact the contact springs of the connector, and then fixes the conductor with the contact springs by a thermal casing to crimp the transmission line with the connector. However, such assembly method is benefit for production, but there is hardly performance for noise blocking. Therefore, the cable made by the assembly method is mostly used for testing or products with loose requirements, which cannot be used in the cable modem and the cable television set-top box with relatively strict requirements.

Therefore, in order to improve signal quality, there is a need to design a connector combination capable of noise blocking to apply to the cable modem and the cable television set-top box.

### SUMMARY OF THE INVENTION

It is therefore an objective of the present invention to provide a connector combination in which a woven shield of a transmission line is soldered with a soldering area of a connector to completely block noise.

The present invention discloses a connector combination includes a transmission line and a connector. The transmission line includes a woven shield for providing a signal reference of a radio-frequency signal, and blocking noise to prevent the radio-frequency signal from being interfered with the noise. The connector is coupled to the transmission line, includes a pipe, wherein a soldering area is formed on the pipe for allowing the woven shield to be soldered with the pipe after the transmission line is combined with the connector.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a sectional view of a transmission line according to an embodiment of the present invention.

FIG. 2 illustrates a sectional view of an F-connector according to an embodiment of the present invention.

FIG. 3 illustrates an assembly diagram of a connector combination according to an embodiment of the present invention.

### DETAILED DESCRIPTION

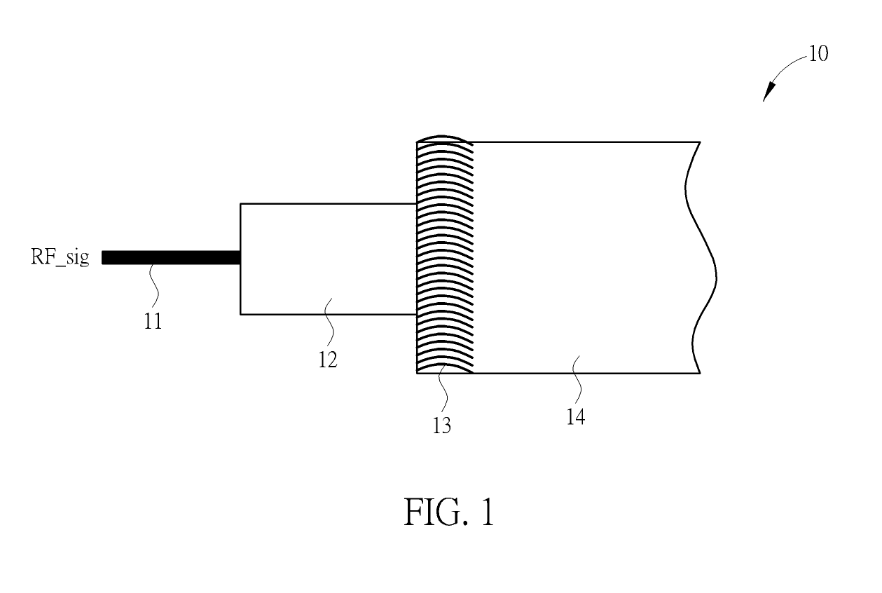

FIG. 1 illustrates a sectional view of a transmission line 10 according to an embodiment of the present invention. The transmission line 10 is preferably a transmission line with a characteristic impedance, such as a coaxial cable with 75 ohms characteristic impedance. The transmission line 10 includes an conductor 11, an cable dielectric 12, a woven shield 13 and an cable jacket 14. The conductor 11 is disposed inside the transmission line 10 for transmitting a radio-frequency signal RF_sig. The cable dielectric 12 is formed between the conductor 11 and the woven shield 13 for insulating the conductor 11 from the woven shield 13. The woven shield 13 is used for providing a signal reference of the radio-frequency signal RF_sig, and blocking noise to prevent the radio-frequency signal RF_sig from being interfered with the noise. The cable jacket 14 covers the woven shield 13 for protecting the woven shield 13 from being short circuited with other circuits, and preventing the woven shield 13 from oxidation to ensure the lifetime of the transmission line 10.

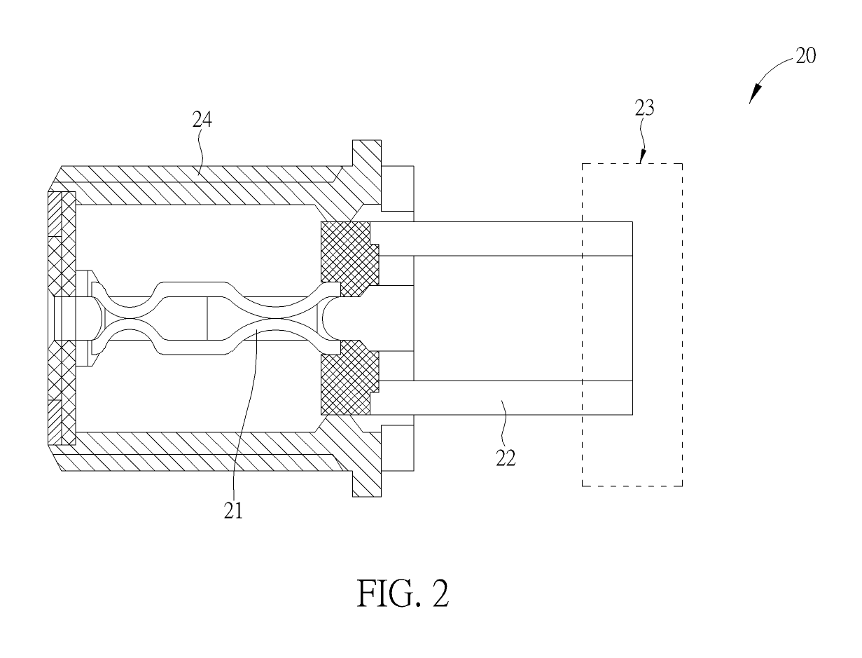

FIG. 2 illustrates a sectional view of an F-connector 20 according to an embodiment of the present invention. The F-connector 20 includes a pair of contact springs 21, a pipe 22, a soldering area 23 and a housing 24. The contact spring 21 is disposed inside the housing 24 for receiving the radio-frequency signal RF_sig from the transmission line 10. The housing 24 is coupled to a ground of an electronic device to provide grounding. An end of the pipe 22 is coupled to the housing 24, where the transmission line 10 can be inserted into the F-connector 20 through the pipe 22. Another end of the pipe 22 is formed with the soldering area 23, where the soldering area 23 allows the woven shield 13 to be soldered with the soldering area 23 to electrically connect with the pipe 22 after the transmission line 10 is combined with the connector 20.

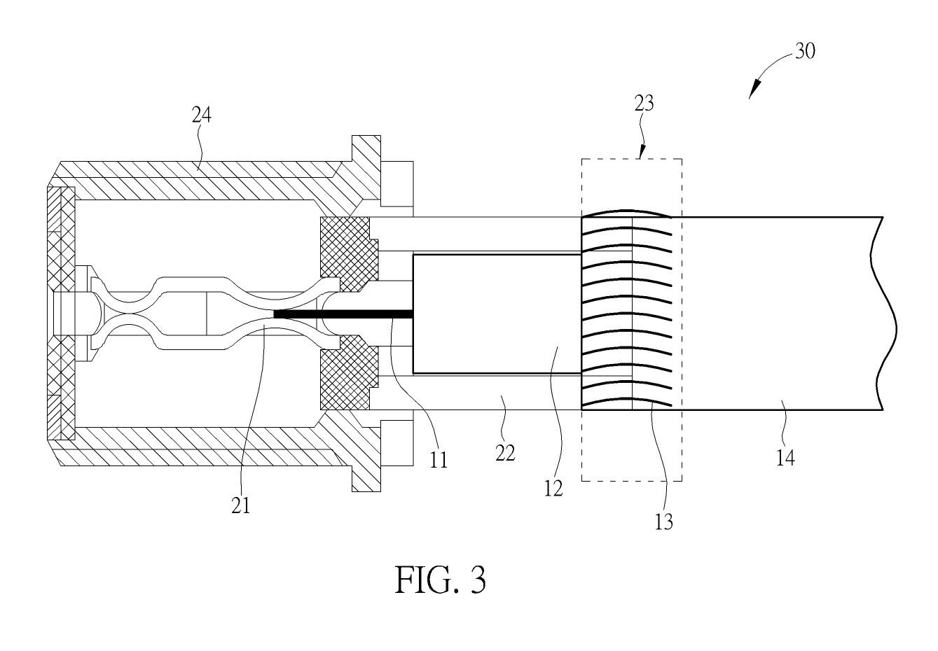

FIG. 3 illustrates an assembly diagram of a connector combination 30 according to an embodiment of the present invention. In a manufacturing assembly line of the electronic device, the operator can combine the transmission line 10 with the F-connector 20, insert the conductor 11 between the two contact springs 21 through the pipe 22, and disposed the cable dielectric 12 inside the pipe 22. The soldering area 23 is overlapped with the woven shield 13, thereby the operator can perform soldering (e.g., circumferential welding) to solder the woven shield 13 with the soldering area 23, and the woven shield 13 is electrically connected to the pipe 22. As a result, by soldering, the woven shield 13 and the pipe 22 are connected seamless to conductivity between each other, so the noise can be completely blocked. For example, under the circumstance that the woven shield 13 and the pipe 22 are connected seamless, the noise cannot interfere with the radio-frequency signal RF_sig through any seams between the woven shield 13 and the pipe 22.

Based on the transmission line theory, the radio-frequency signal RF_sig is reflected if its signal path and signal reference encounter discontinuous impedances, which lead to bad signal quality of the radio-frequency signal RF_sig. An insertion loss is defined as a ratio of transmitted signal and incident signal, and a return loss is defined as a ratio of reflected signal and incident signal. Accordingly, given that the F-connector 20 and the transmission line 10 have the same impedance, e.g., 75 ohms, to be matched with each other, so as to ensure the signal quality of the radio-frequency signal RF_sig.

Note that the woven shield 13 and the pipe 22 can be seamlessly connected by soldering, so the signal reference of the radio-frequency signal RF_sig can have continuous impedance to improve the insertion loss and the return loss, thereby meet the application requirements and design standards.

In other words, the present invention reserves the soldering area for the pipe of the F-connector, so the woven shield of the transmission line can be soldered with the soldering area to seamlessly combine the woven shield with the pipe. Therefore, the noise can be completely blocked, and the insertion loss and the return loss can be improved to meet the application requirements and design standards. Those skilled in the art can make modifications and alterations according to the structure and operations above mentioned, which is not limited to the embodiments of the present invention.

For example, the woven shield and the pipe can be connected by any means of metal welding. The characteristics impedances of the transmission line and the F-connector are variable as long as they are matched. The pipe can be made of any kinds of metal materials.

In addition, torque test should be considered on where the F-connector and transmission line are connected (i.e., where the woven shield and the pipe are soldered with) to ensure the lifetime of the connector combination 30. In one embodiment, at two sides of the pipe, two retainers are used for fixing the pipe, where the two retainers can be formed with the pipe in one piece. In another embodiment, the pipe can be fixed with the two contact springs by riveting and metal welding. Furthermore, the housing is connected to the pipe by at least one of metal welding, soldering and riveting to ensure the housing and the pipe are seamlessly connected to completely block the noise.

To sum up, the present invention reserves the soldering area for the pipe of the F-connector, so the woven shield of the transmission line can be soldered with the soldering area to seamlessly combine the woven shield with the pipe. Therefore, the noise can be completely blocked, and the insertion loss and the return loss can be improved to meet the application requirements and design standards.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A connector combination, comprising:
a transmission line, comprising a woven shield, for providing a signal reference of a radio-frequency signal, and blocking noise to prevent from being interfered with the noise; and
a connector, coupled to the transmission line, comprising a pipe, wherein a soldering area is formed on the pipe for allowing the woven shield to be soldered with the pipe after the transmission line is combined with the connector.

2. The connector combination of claim 1, wherein the transmission line further comprises:
a conductor, for transmitting the radio-frequency signal;
a cable dielectric, formed between the conductor and the woven shield; and
a cable jacket, covering the woven shield.

3. The connector combination of claim 2, wherein the connector further comprises:
a housing, coupled to the pipe and a ground of an electronic device to provide grounding; and
two contact springs, disposed inside the housing for receiving the radio-frequency signal from the transmission line after the transmission line is combined with the connector.

4. The connector combination of claim 3, wherein the pipe is fixed with the two contact springs by riveting and metal welding.

5. The connector combination of claim 3, wherein the housing is connected to the pipe metal welding, soldering or riveting.

6. The connector combination of claim 1, wherein at two sides of the pipe, two retainers are used for fixing the pipe, where the two retainers are formed with the pipe in one piece.
